(19) United States
(12) Patent Application Publication
(10) Pub. No.: US 2018/0096753 A1
(43) Pub. Date: Apr. 5, 2018

(54) DATA CABLE

(71) Applicant: Leoni Kabel GMBH, NUERNBERG (DE)

(72) Inventors: Melanie Dettmer, Heede (DE); Jens Liebel, Jemgum (DE); Uwe Rudorf, Ahrensfelde (DE); Ruediger Schmidt, Moormerland (DE)

(21) Appl. No.: 15/831,664

(22) Filed: Dec. 5, 2017

Related U.S. Application Data
(63) Continuation of application No. PCT/EP2016/061422, filed on May 20, 2016.

(30) Foreign Application Priority Data
Jun. 5, 2015 (DE) 102015210389.7

(51) Int. Cl. H01B 7/295; H01B 3/04; H01B 3/08; H01B 7/29

(52) U.S. Cl. CPC H01B 7/295; H01B 3/04; H01B 11/02; H01B 7/292; H01B 3/082

(57) ABSTRACT

A data cable includes a plurality of cores each having a conductor surrounded by core insulation, providing the cores with a plurality of prescribed telecommunications transmission parameters. The core insulation includes a plurality of flame-retardant layers having a mineral, electrically insulating and flame-resistant first material, for maintaining functional integrity in the event of fire.

### CROSS-REFERENCE TO RELATED APPLICATION

This application is a continuation, under 35 U.S.C. § 120, of copending International Application PCT/EP2016/061422, filed May 20, 2016, which designated the United States; this application also claims the priority, under 35 U.S.C. § 119, of German Patent Application 10 2015 210 389.7, filed Jun. 5, 2015; the prior applications are herewith incorporated by reference in their entirety.

### BACKGROUND OF THE INVENTION

### Field of the Invention

The invention relates to a data cable.

A data cable serves to transmit signals or data and normally includes a plurality of cores, which are combined into pairs or star quads, for example. Examples of data cables are so-called Ethernet cables of category 5, 6 or 7. The transmission behavior of these cables is usually standardized and is specified e.g. in the IEC 61156-5 or IEC 61156-6 standard. The functionality of a data cable is determined substantially by a number of telecommunications transmission parameters, such as impedance, damping and return loss of a respective core. In order to ensure the required transmission properties, in particular in a way that conforms to standards, each of the individual cores of the data cable typically has a conductor as well as core insulation surrounding the conductor. The core insulation is thus often manufactured from a suitable dielectric synthetic material in order to ensure the required transmission properties and to realize suitable transmission parameters, such as providing a suitable impedance for each core. A synthetic material that is often selected is polyethylene, for example.

However, conventional data cables are only insufficiently protected in case of fire. In particular, a problem arises in that the synthetic materials selected to produce the core sheaths melt or burn when subjected to fire, and a short circuit is then possible among multiple conductors of the data cable. Furthermore, the impedance provided by the core insulation is also no longer ensured in case of fire, and therefore the data cable is no longer suited overall for transmitting data. The result is a loss of functionality of the data cable in the event of fire.

### SUMMARY OF THE INVENTION

It is accordingly an object of the invention to provide a data cable, which overcomes the hereinafore-mentioned disadvantages of the heretofore-known cables of this general type and which maintains functional integrity for the data cable in case of fire, i.e. a data cable with which it is possible to continue in particular standard-conforming data transmission for as long as possible, even once exposed to fire, e.g. data transmission according to IEC 61156-5.

With the foregoing and other objects in view there is provided, in accordance with the invention, a data cable, comprising a plurality of cores, each of the cores having a conductor and core insulation surrounding the conductor to provide the cores with a plurality of prescribed telecommunications transmission parameters, and the core insulation including a plurality of flame-retardant layers having a mineral, electrically insulating and flame-resistant first material, for maintaining functional integrity in an event of fire.

The data cable includes a plurality of cores, which are configured in particular to transmit data or signals. In particular, multiple cores are taken combined as a core assembly into a data line, for example as core pairs or as a quad stranding unit, in particular as star quads. Each of the cores has a conductor that is surrounded by a core insulation, through the use of which the corresponding core is configured with multiple predetermined telecommunications transmission parameters, or simply transmission parameters for short. In particular, a respective data line is also configured with corresponding telecommunications transmission parameters in this way. Telecommunications transmission parameters of this type include impedance, damping or return loss, for example. In order to create the transmission parameter, the core insulation is manufactured in particular of a synthetic material, which serves as a dielectric that surrounds the conductor and thereby defines the transmission properties of the cores and especially of the data lines. In order to ensure functional integrity during a fire, the core insulation has multiple flame-retardant layers with a mineral, electrically insulating and flame-resistant first material. In this case, functional integrity is understood in particular to mean that the transmission parameters of each core and thus the telecommunications transmission properties of the data cable are substantially preserved and in particular fulfill the relevant standard for the data cable.

A central concept of the invention resides in particular in that the core insulation is especially flame-resistant because of the flame-retardant layers and, as a result, the data cable can continue to be used as such during a fire. An advantage of the flame-retardant layers is found especially in the fact that the principal structure of the core insulation is also largely preserved when subjected to fire. The choice of a mineral first material in particular also prevents fusing of the core insulation in case of fire, as a result of which the impedance of the cores is advantageously preserved and thus the overall functionality of the data cable, as well. A mineral material is understood in particular to be a material that is not organic and especially not synthetic. Additionally, since the first material is also electrically insulating, the conductors of the cores are sufficiently electrically separated from one another. Therefore, the data cable can still be used to transmit data, at least over a particular period of time, even in case of fire. Accordingly, functional integrity during a fire is ensured by the specifically configured core insulation. A data cable constructed in this way is suited in particular, for example, for use in shipbuilding, in the off-shore industry, in refineries, tunnels or public buildings.

An important aspect of the invention is especially that the mineral material does not only assume the functions of fusing components of the data cable, in particular the core insulation, in the event of a fire, but instead already substantially defines the transmission properties during normal operation. Since the mineral material is especially flame-resistant, the transmission properties are particularly well-protected during a fire, since most or even all of the core insulation is preserved during a fire and, as a matter of principle, in the same or at least a predominantly similar configuration as during normal operation.

Functional integrity is especially important in data cables. It is vital in this case to distinguish between the terms functional integrity and insulation integrity. Significant to insulation integrity is that the insulation, in particular the core insulation, is preserved as such and that a short circuit is prevented. However, functional integrity goes further: not only is preventing a short circuit important for functional integrity, but also retaining the concrete transmission properties. Simply put: while insulation integrity only comes down to whether or not the core insulation is preserved, functional integrity additionally depends upon the shape or condition in which the core insulation is preserved. As long as no short circuit occurs, a deformation and thus a change in the transmission properties and parameters is not critical for insulation integrity, but it is significant for functional integrity.

Data cables are generally used for digital data transmission at frequencies in the megahertz range; for instance, if a category 5E (cat 5E) cable has a maximum transmission frequency of 250 MHz, then that of a category 7 (cat 7) cable is up to 600 MHz. Higher transmission frequencies are also possible. By contrast, conventional cables for telecommunications have comparatively low maximum transmission frequencies in the kilohertz range, e.g. up to 100 kHz, and transmission is usually analog rather than digital, as with data cables. Cables for transmission of energy, e.g. in the field of power engineering, are operated at much lower frequencies or even with direct current voltage. In telecommunications cables and energy transmission cables, the transmission properties depend less upon the core insulation; deformation as a result of fire is less critical for their functionality than in data cables. Accordingly, insulation integrity and functional integrity coincide in telecommunications cables, but not in data cables. They are subject to higher demands in this regard.

In the case of a telecommunications cable, e.g. a telephone cable, only the insulation integrity of the core insulation is usually required, and possibly a change in capacitance among multiple core pairs of no more than 30%, as well. On the other hand, a data cable regularly requires concrete threshold values for the transmission parameters. Normal requirements for data cables are, for instance, no short circuit for voltages up to 100 VDC or up to 70 VAC, a maximum difference in damping of 8.5 dB in the range between 1 and 10 MHz, a return loss greater than 8 dB and a crosstalk attenuation greater than 26-15 log₁₀(f/10) dB for frequencies f between 1 and 10 MHz. Adhering to the concrete values is critical for the functioning of the data cable. These stated requirements are satisfied, even in case of fire, in particular by the data cable according to the invention.

In a preferred development, the core insulation is configured as a mixed dielectric and, in addition to the flame-retardant layers, has at least one insulation layer formed of an electrically insulating second material. One advantage of a mixed dielectric of this type is especially that the impedance of each core can be adjusted by the appropriate combination of the first and second materials.

Moreover, the additional insulation layer also permits enhanced protection of the conductor, particularly during regular use, i.e. not during a fire. In a preferred development, the insulation layer is continuous for this reason. In this way, the conductor of each core is completely surrounded by the insulation layer in an advantageous manner and is therefore continuously protected both against environmental factors, such as the ingress of moisture, and against an inadvertent short circuit, such as from contact with other conductors of the data cable. In order to make the insulation layer continuous, it is extruded onto the conductor in solid or foamed form, for example. Alternatively, the insulation layer is wrapped, laid or folded around the conductor as a film or banding and then heat-sealed or glued.

It is expedient to manufacture the insulation layer from a synthetic material, which makes it particularly easy to apply it, especially to extrude it, onto the conductor. In a suitable variant, the insulation layer is thus extruded, i.e. formed by using an extrusion process. In particular, the insulation layer is made of polyethylene (PE), polypropylene (PP) or a copolymer. In addition to advantageous processing properties, these synthetic materials also exhibit a suitable insulating effect.

In one practical development, a fire-retardant or flame-resistant material, such as a mineral additive, is admixed into the insulation layer. In this way, the flame resistance of each core and thus also the functional integrity of the entire data cable during a fire are further improved.

In case of fire, there is the particular risk that the insulation layer will melt or burn off and that the transmission parameters of each core and/or data line will thereby be disadvantageously altered, as a result of which the function of the data cable might no longer be ensured. n order to keep the influence of a melting insulation layer and associated change in the transmission parameters as minor as possible, the insulation wall thickness of the insulation layer is preferably no more than 35%, especially no more than 10%, of a total wall thickness of the core insulation. In the event of fire, the core insulation remains in particular structurally intact for the most part overall, despite melting or burning of the insulation layer, and therefore the appropriately adjusted transmission parameters are also preserved as much as possible, and preferably remain within the range of values specified by the relevant standard. In other words: By appropriately selecting the wall thickness of the insulation layer proportionately to the total wall thickness of the core insulation, the contribution by the insulation layer to the transmission parameters of the core is adjusted in such a way that a deformation of the insulation layer exerts only a minor influence on the transmission parameters of the core and especially the respective data line, to which the core belongs. Accordingly, the insulation layer contributes only slightly to the impedance, whereby functional integrity is established within the tolerance of the impedance. For example, the total wall thickness is approximately 400 pm, and the insulation wall thickness is then accordingly no more than approximately 100 pm.

The aforementioned similarly applies to all telecommunications transmission parameters of the data cable. A central concept in this case is to configure the insulation layer as thin as possible compared to the mineral material so that, even during normal operation, the transmission properties are primarily determined by the mineral material. If the insulation layer melts in a fire, then this will advantageously have only little or no effect on the transmission properties; the transmission parameters change insignificantly at most; at least the values described further above for the transmission parameters will be maintained. This is in contrast to a merely subordinate use of mineral materials in cables, in which the transmission properties are predominantly defined by the insulation layer and necessarily undergo a significant change in the event of a fire as a result of the destruction of the insulation layer. In this case, a mineral material is used merely as a “sleeping” material, so to speak, which takes effect only in the event of a fire but performs no function during normal operation. The mineral material then serves only to prevent a short circuit, i.e. to provide simple insulation integrity but not functional integrity. In the embodiment of the data cable described herein, however, real functional integrity is advantageously realized for that very situation due to the specific, in particular thin insulation layer. Furthermore, the mineral material also performs an important function during normal operation, namely the concrete configuration of the transmission properties, i.e. in particular establishing particular values for the transmission properties.

The preferred insulation wall thickness depends in particular on the configuration of the insulation layer relative to the flame-retardant layers. In general, the insulation wall thickness preferably corresponds to no more than 10% of the total wall thickness. However, in the case of an insulation layer applied to the conductor, an insulation wall thickness of up to a maximum of 25% of the total wall thickness is also suitable. By contrast, if an insulation layer is applied externally to the flame-retardant layers, then an insulation wall thickness of up to a maximum of 35% of the total wall thickness is also appropriate. This difference results in particular from the generally different contributions to the transmission parameters as a function of the distance between the insulating layer and the conductor. Accordingly, an insulation layer disposed further inward exerts a greater influence in particular and is thus preferably thinner than an insulating layer lying further outward.

The flame-retardant layers can have various irregularities, depending on their configurations. The insulation layer is thus preferably applied directly to the conductor, in particular extruded onto it, and is thereby disposed within the flame-retardant layers in particular. In this way, the insulation layer is particularly homogeneous and therefore the transmission parameters and, accordingly, the transmission properties along the core are also particularly homogeneous. Possible irregularities are advantageously prevented. In principle, though, a placement in the insulation layer around the flame-retardant layers or between multiple flame-retardant layers is also conceivable.

In a suitable alternative, the core insulation is constructed exclusively of the flame-retardant layers and in particular does not include an additional insulation layer. Accordingly, this embodiment foregoes an insulation layer that could possibly melt in the event of a fire, and therefore so the transmission parameters of the core insulation are especially well preserved in a fire as a result of the flame-resistant flame-retardant layers.

The transmission parameters of each core or data line are normally prescribed by a corresponding standard for the data cable. For instance, the impedance of a data line formed as a core pair should be 100 Ω. The actual impedance of each data line relies in particular on the material and total wall thickness of the core insulations. In order to adjust the prescribed impedance of a given data line, its core insulations preferably have multiple flame-retardant layers. By making the appropriate choice of the exact number of flame-retardant layers, possibly in combination with an additional insulation layer, the total wall thickness of the core insulation is then adjusted in such a way that the prescribed impedance is achieved.

With the stipulations of flame resistance and electrical insulation, mineral byproducts like mica or glass fiber in particular are suitable as a first material of a given flame-retardant layer. These mineral materials are distinguished by especially good flame resistance and also usually do not melt when subjected to fire. Accordingly, the use of these materials also largely preserves in particular the shape of the core insulation in the case of fire; this means that the total thickness of the core insulation and thus its transmission parameters also remain particularly well preserved.

Each of the flame-retardant layers is preferably configured as a wrapping. This is understood in particular to mean that the flame-retardant layers are each configured as banding or mesh. This permits the aforementioned materials in particular, i.e. mica and glass fiber, but also any mineral materials in general to be used in an especially simple way to form core insulation. For example, glass fiber is woven, knitted or spun around the conductor as a mesh. A thin layer of mica is applied to a backing film, for instance, which is then banded or spun around the conductor or is wrapped around the conductor with a longitudinal seam.

Since wrapping the conductor can possibly leave gaps and/or spaces and since it generally creates accessibility to the inside of the core, this embodiment is preferably combined with an additional insulation layer, as described above. In this combination, the insulation layer then ensures continuous coverage and physical screening, so to speak, of the conductor relative to the environment and other conductors, wherein the flame resistance and functional integrity are provided by the flame-retardant layers.

In order to achieve the most uniform transmission parameters and thus transmission properties possible especially along the entire data cable, the respective core insulations are also configured as homogeneously as possible, i.e. with a total wall thickness that is as uniform as possible. Especially in the case of banding, the flame-retardant layer is wound around the conductor as a band particularly helically and normally has a multitude of coils, which overlap in the edge region of the band and thus form an overlap, within which correspondingly more material is disposed. In one practical embodiment, each flame-retardant layer is thus formed with an overlap of no more than 20%, in particular no more than 10% and preferably edge to edge, i.e. with no overlap. This results in especially defined and sufficiently uniform transmission parameters in the respective core along the data cable.

In one practical alternative, the overlap measures approximately 49%. Particularly when there are multiple flame-retardant layers, the result is a covering for the conductor that is optimal on the whole. Due to the 49% overlap, a respective flame-retardant layer is practically double-walled, since approximately half of each coil of the wrap is covered by the previous and the following coil. The formation of an exposed gap is prevented by this double-layered configuration. Based on the approximately 49% overlap, the previous and the following coil are thus nearly wound edge to edge, and the remaining gap is covered by the coil between them. The phrase “approximately 49%” is thereby understood to be an overlap that is formed by such double-layered edge to edge winding, in particular an overlap of at least 47% and no more than 50%.

Since an edge to edge wrapping, i.e. without an overlap, can be difficult to manufacture, one practical embodiment with multiple flame-retardant layers places the overlap of a first of the flame-retardant layers in the longitudinal direction in such a way that it is offset from the respective overlap of the remaining flame-retardant layers. Despite corresponding overlaps of each flame-retardant layer, by skillfully combining multiple flame-retardant layers it is thus possible to place the overlaps offset from each other in such a way that a homogeneous and constant total wall thickness is nevertheless produced. In other words: the core insulation preferably includes multiple flame-retardant layers, each of which has an edge, wherein in particular the edges of different flame-retardant layers are disposed offset from each other.

In order to maintain the function of the data cable in the event of fire, it is practical to preserve the transmission parameters of the individual cores to the greatest extent possible, i.e. to avoid deviating too much from the respective prescribed value. Preferably, for example, the impedance in a data cable according to IEC 61156-5 or IEC 61156-6 changes by no more than 20%, especially no more than 10%, during a fire in order to maintain functional integrity. In this way, the usual tolerances of the relevant standards are also upheld in the event of fire. For instance, the core insulation with an insulation layer is constructed in such a way that the impedance is still within the tolerance, e.g. if 110 Ω, then 10% above an ideal value of 100 Ω. If the insulation layer then melts or burns in a fire, the impedance falls by no more than 20% to a corresponding 90 Ω, and is thus still within the tolerated range of values so that standard-conforming data transmission continues to be ensured.

In the event of fire, functional integrity is maintained especially for a particular minimum period. Additionally, in a preferred embodiment the transmission parameters and thus advantageously the transmission properties are maintained during a fire for a period of at least 30 minutes, in particular at least 90 minutes and preferably at least 180 minutes.

The embodiment variants of the cores and data lines described above already ensure particularly good fire-proofing and functional integrity in the event of a fire. As a further improvement, the data cable in one advantageous development has a cable sheath that surrounds the data lines and their cores and that includes a layer constructed of a flame-resistant material. In addition to the flame-resistant flame-retardant layers of the individual core insulations, they are thus surrounded by a further layer of flame-resistant material. The flame resistance of the entire data cable is further improved in this way. A synthetic material with an appropriate admixture, such as a halogen-free polyethylene material, for instance, is suitable for use as a flame-resistant material. This synthetic material is then extruded on for example, and it thereby forms a flame-resistant sheath, especially continuous, for the data lines and the cores in general. Alternatively or additionally, a flame-resistant film is wrapped around the data lines and generally around the cores.

In a practical embodiment, the data cable has a cable shield, which surrounds the cores, especially all cores, and is configured in particular to electrically shield the cores, especially the data lines, from the environment and vice versa. In one preferred variant, the cable shield is integrated in particular into the cable sheath, e.g. as a mesh or wrapping, and is manufactured e.g. of tin-plated copper wires.

In a further suitable embodiment, the data cable has a reinforcement, which surrounds the data lines in particular and the cores in general and which in particular provides mechanical stability. For example, the reinforcement is configured as a steel mesh and is integrated into the cable sheath. Expediently, the reinforcement simultaneously serves as additional heat protection.

In a preferred embodiment, the cable has multiple cores, which in particular are twisted into pairs and combined into a plurality of data lines. These data lines are surrounded by a common cable sheath. Additionally or alternatively, it is expedient for the data lines to be twisted with one another.

In a practical development, each of the data lines has a line shield, i.e. the cores belonging to each data line are all surrounded by one line shield. In particular, this line shield serves to shield the various data lines from one another.

Other features which are considered as characteristic for the invention are set forth in the appended claims.

Although the invention is illustrated and described herein as embodied in a data cable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1, 2 and 3 are diagrammatic, cross-sectional views each showing a variant of a data cable; and

FIG. 4 is a fragmentary, side-elevational view of a conductor with an insulation layer and flame-retardant layer.

### DETAILED DESCRIPTION OF THE INVENTION

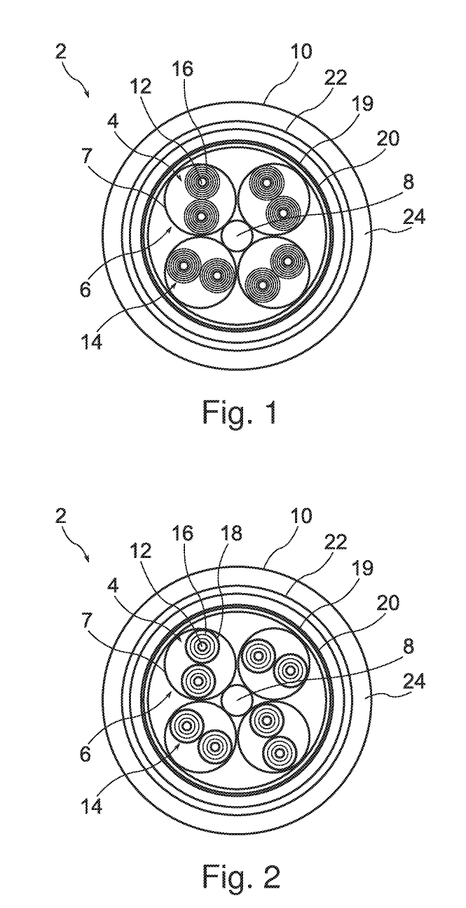

Referring now to the figures of the drawings in detail and first, particularly, to FIGS. 1-3 thereof, there are seen embodiments of a data cable 2. The cable has a plurality of cores 4, which in the embodiment variants shown herein are respectively combined by pairs into data lines 6. In the embodiment variants shown herein, each of the data lines 6 is surrounded by a line shield 7 to shield them from one another. In each of FIGS. 1 through 3, a total of eight cores 4 are organized into four data lines 6. The data lines 6 are grouped around a central element 8, which is configured in particular as a tension-relieving device. The data cable 2 further includes a cable sheath 10, which surrounds the cores 4.

Each of the cores 4 has a conductor 12, which is surrounded by a core insulation 14. Each of FIGS. 1 through 3 now shows embodiments with different variants of this core insulation 14. For instance, the core insulation 14 in FIG. 1 has a plurality, in particular six in this case, of flame-retardant layers 16 that are banded around the conductor 12 as mica film, for example, or alternatively are wrapped around the conductor 12 as glass fiber.

By contrast, FIG. 2 shows an embodiment in which only three flame-retardant layers are applied to the conductor and are then surrounded by an additional insulation layer 18. Those layers 18 are made of a synthetic material, e.g. a polyethylene, and are produced continuously, in particular extruded.

In FIG. 3, the core insulation 14 is configured in such a way that an insulation layer 18 is initially applied directly onto the conductor 12. This insulated conductor 12 is surrounded, in particular wrapped up, by a plurality of flame-retardant layers 14, in this case three. In a non-illustrated alternative, the insulation layer 18 is disposed between two flame-retardant layers 14.

The cable sheath 10 in FIGS. 1 through 3 is multi-layered. A cable shield 19 and a flame-resistant film 20, which surround the data lines 6, are first disposed on the inner side of the cable sheath 10. Furthermore, a reinforcement 22, which in particular in this case is a steel mesh, is integrated into the cable sheath 10. In order to further improve the flame resistance of the data cable 2, a flame-resistant material is admixed with the cable sheath 10, as a result of which a flame-resistant layer 24 is formed, which in this instance additionally forms an outermost layer of the cable sheath 10.

In order to improve the flame resistance of the data cable 2, it is preferred that further layers or bandings be additionally or alternatively provided, which are disposed inwardly and/or outwardly relative to the cable shield 19. Bandings of this type are formed, for example, by mica tapes and/or glass fiber tapes.

Furthermore, the ratio of the wall thicknesses of the insulation layer 18 and the flame-retardant layers 16 can be seen in FIG. 3. For instance, the core insulation 14 has a total wall thickness G, and the insulation layer 18 has an insulation wall thickness I, wherein the insulation wall thickness I is only about one-fourth of the total wall thickness G.

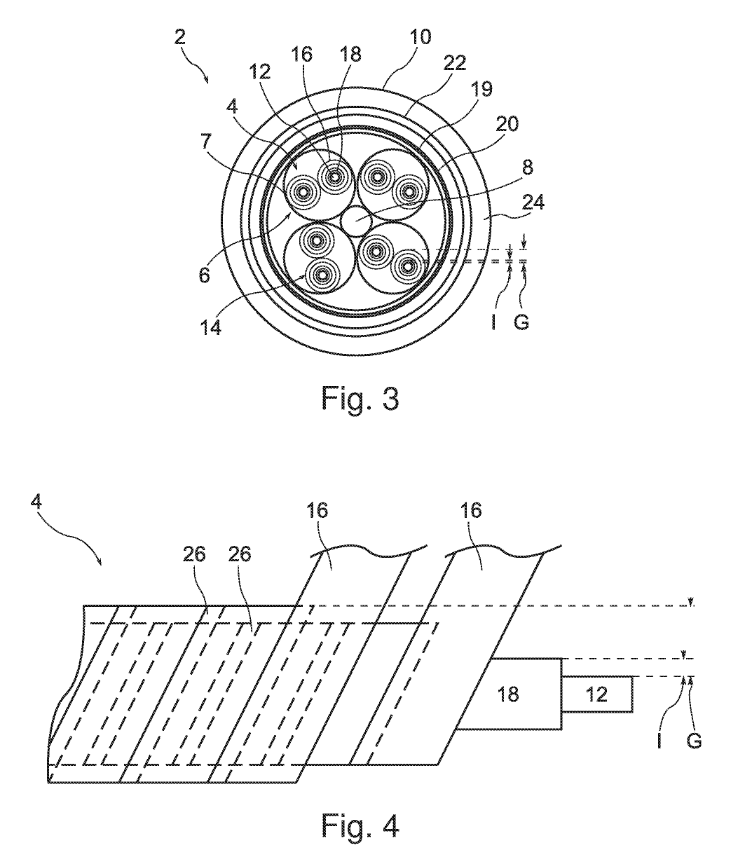

FIG. 4 shows a side view of a core 4 of the data cable 2, in which one insulation layer 18 has already been applied to the conductor 12 of the core 4. That insulation layer 18 is itself wrapped in a plurality, in this case two, of flame-retardant layers 16, which in this instance are each configured as banding. Moreover, each of the flame-retardant layers 16 in this case is a mica layer, which is applied to a backing film that is wrapped around the conductor 12 and the insulation layer 18. Due to the helical wrapping, this results in an overlap 26 of two consecutive coils of a respective flame-retardant layer 16. This overlap 26 is made to be as minimal as possible. Preferably, the edges of the flame-retardant layer 16 are wound edge to edge so that there is accordingly no overlap 26.

The inner of the two flame-retardant layers 16 is shown partially with a dashed line in FIG. 4, as is the concealed overlap 26 of the outer flame-retardant layer 16, in order to emphasize that each of these is covered by the outer flame-retardant layer 16. It can clearly be seen that the overlap 26 of the outer flame-retardant layer 16 is offset in the longitudinal direction L of the core 4 relative to the overlap 26 of the first flame-retardant layer 16, and therefore there is an especially homogeneous distribution of the overlaps 26 overall and thus an especially homogeneous impedance along the data cable 2.

1. A data cable, comprising:
a plurality of cores;
each of said cores having a conductor and core insulation surrounding said conductor to provide said cores with a plurality of prescribed telecommunications transmission parameters; and
said core insulation including a plurality of flame-retardant layers having a mineral, electrically insulating and flame-resistant first material, for maintaining functional integrity in an event of fire.

2. The data cable according to claim 1, wherein said core insulation is formed as a mixed dielectric having at least one insulation layer formed of an electrically insulating second material, in addition to said flame-retardant layers.

3. The data cable according to claim 2, wherein said insulation layer is continuous.

4. The data cable according to claim 2, wherein said insulation layer is formed of a synthetic material.

5. The data cable according to claim 4, wherein said synthetic material is PE, PP or a copolymer.

6. The data cable according to claim 2, which further comprises a fire-retardant material admixed into said insulation layer.

7. The data cable according to claim 2, wherein said insulation layer has an insulation wall thickness corresponding to no more than 35% of a total wall thickness of said core insulation.

8. The data cable according to claim 7, wherein said insulation wall thickness corresponds to no more than 10% of said total wall thickness of said core insulation.

9. The data cable according to claim 2, wherein said insulation layer is applied or extruded directly onto said conductor.

10. The data cable according to claim 1, wherein said core insulation is formed exclusively of said flame-retardant layers.

11. The data cable according to claim 1, wherein said plurality of flame-retardant layers of said core insulation adjust a prescribed impedance of a given one of said cores.

12. The data cable according to claim 1, wherein said first material of each of said flame-retardant layers is mica or glass fiber.

13. The data cable according to claim 1, wherein each of said flame-retardant layers is formed as a wrapping.

14. The data cable according to claim 1, wherein each of said flame-retardant layers is applied with an overlap of no more than 20%, is applied with an overlap of no more than 10% or is applied edge to edge.

15. The data cable according to claim 13, wherein each of said flame-retardant layers is applied with an overlap of approximately 49%.

16. The data cable according to claim 13, wherein each of said plurality of flame-retardant layers of said core insulation has an edge, and said edges of different flame-retardant layers are offset from one other.

17. The data cable according to claim 1, wherein an impedance of the data cable changes by no more than 20% during a fire in order to maintain functional integrity.

18. The data cable according to claim 17, wherein said impedance is preserved during a fire for a period of at least 30 minutes or at least 90 minutes or at least 180 minutes.

19. The data cable according to claim 1, which further comprises a cable sheath surrounding said cores, said cable sheath including a layer constructed of a flame-resistant material.

20. The data cable according to claim 1, which further comprises a cable shield surrounding said cores.

21. The data cable according to claim 1, which further comprises a reinforcement surrounding said cores.

22. The data cable according to claim 1, wherein said plurality of cores are twisted and combined into a plurality of data lines, and a cable sheath commonly surrounds said plurality of data lines.

23. The data cable according to claim 22, wherein each of said data lines has a respective line shield.
